(19) United States
(12) Patent Application Publication
(10) Pub. No.: US 2005/0246268 A1
(43) Pub. Date: Nov. 3, 2005

(54) Funds transfer method and system

(75) Inventors: John Anthony Foran, Dublin (IE); Joseph Patrick Corcoran, Dublin (IE); Christopher Michael Murphy, Dublin (IE)

Correspondence Address: BIRCH STEWART KOLASCH & BIRCH, PO BOX 747, FALLS CHURCH, VA, 22040-0747, US

(73) Assignee: INTER-NET PAYMENTS PATENTS LIMETED, Bray (IE)

(21) Appl. No.: 10/524,767

(22) PCT Filed: Aug. 18, 2003
(86) PCT No.: PCT/IE03/00111

§ 371 Date: Jul. 13, 2005

(30) Foreign Application Priority Data
Aug. 16, 2002 (IE) S2002/0679

(51) Int. Cl. G06F 17/60

(52) U.S. Cl. 705/39

(57) ABSTRACT

A funds transfer method in a communications system between two entity computers where, depending on the transaction, one is remitter computer and the other is a recevier computer. There is a systems server computer associated with an escrow account. Once a transaction has been agreed between the two computers, the systems server computer sets aside the funds in the escrow account, which funds are no longer available to the remitter computer which will often be operated by a buyer in the internet. Then the systems server computer issues two codes, namely, an initial initiation code and a funds release code respectively. The initiation code is sent to the receiver computer as confirmation of the availability of the funds in the escrow account. The other funds release code is with the remitter computer which sends the code to allow release of the funds on completion of a specified event occurring such a expiry of an agreed settlement date, acceptance by the remitter that the trade to which the transaction relates was satisfactorily completed or indeed any other agreed outcome. The invention allows for negotiations to take place between the parties, if a dispute should arise by postponing the expected settlement data until, if no resolution of the dispute can be found by negotiation between the parties, a formal alternative dispute resolution procedure is set up.

The present invention relates to a funds transfer method in a system comprising a plurality of entity computers and a system server computer Interconnected, by a communications network.

Secure transfer of funds is required in many situations but particularly in situations where the parties are remote and do not meet face to face to complete a transaction. The transaction can be a very simple financial transaction, for example, a parent transferring funds to a child in some other jurisdiction or transferring funds to somebody else in another jurisdiction or indeed at a remote location within the same jurisdiction. The person transferring the funds and the person receiving the funds always have considerable problems as to the security of the transfer. A further problem arises where there is actual trading taking place between a buyer and seller. Then the transaction is part of a larger or more complex commercial transaction. Very often, the buyer has to transfer funds before the goods are received, the seller being obviously reluctant to send the goods without receiving payment. At the same time, the buyer is often unaware as to the merchantable quality of the goods being purchased, particularly where they have to be delivered, or indeed, as to the service, for example, where the service can be delivered on line. There is thus, in effect, a reluctance for the buyer to trust the seller to provide the goods or services to the quality and standard required and the seller is equally reluctant to provide those goods or services until he or she has been paid. This is a major problem where the buyers and sellers are unknown to each other or where neither of them have an established trading or credit record. Internet auction sites are a particular example of this.

There are many existing numbers of solutions to these problems such as those sold under the Trade Marks PAYPAL, C2IT and BILL PAY. The problem is that these systems suffer from a high level of disputes related to either a commercial dispute between the parties or fraudulent activity by either of the parties. These disputes result in high costs to the system, that is to say, to the operators of the system, to resolve them.

The present invention is directed towards overcoming these problems and in particular to a more flexible system which would allow parties to a commercial agreement an opportunity to resolve such disputes between themselves prior to resorting to litigation or other third party operated dispute resolution.

### STATEMENTS OF INVENTION

According to the invention, there is provided a funds transfer method in a system comprising a plurality of entity computers each with means to provide an unique entity identification (ID) and a system server computer interconnected by a communications network, the system server computer having an escrow account associated therewith into and out of which funds may be transferred, the method comprising establishing, prior to or during a funds transfer, an entity account for each entity computer with the system server computer and on a funds transfer being desired between two entity computers, designating, as appropriate, one as a remitter computer and the other as a receiver computer and then the steps are performed of:
the remitter computer sends transaction details and the receiver entity ID to the system server computer;
the systems server computer confirms the availability of funds in the escrow account for the receiver computer entity account, which funds are no longer available to the remitter computer;
then, on a specified event occurring, the funds are released from the escrow account to the entity account of the receiver computer.

The advantage of this is that the receiver computer, having the funds in escrow, increases the possibility that the transfer of funds will take place and if the transaction is conducted in a correct and timely manner by the receiver, that is to say, the seller of the goods or services, the funds will be received. At the same time, the buyer or remitter computer has the comfort that they will not be released until a specified event occurs which will have been previously agreed between the remitter computer and the receiver computer.

In one way of carrying out the invention, the method comprises generating two different codes, namely, an initial initiation locking code and a funds release code, in which the locking code is used to control the holding of the funds in the escrow account and the funds release code is used to control the release of the funds from the escrow account. This is an extremely efficient and easy way of carrying out the system.

With this use of two different codes, on the system computer confirming the availability of the funds in the escrow account, the system computer sends the initiation locking code to the remitter computer as confirmation of the availability of the funds in the escrow account for the receiver computer entity account and the funds release code to the remitter computer and on the specified event occurring, the funds release code is sent to the system server computer and the system server computer releases the funds from the escrow account to the receiver computer entity account. Alternatively, on the system server computer confirming the availability of the funds in the escrow account, the system server computer sends the two codes to the remitter computer and if the remitter computer does not send the initiation locking code to the other entity but sends it to the systems server computer, the transaction is cancelled and the funds in the escrow account are released to the remitter entity account

In one embodiment of the invention, the sending of the funds release code to the system server computer comprises:
the remitter computer sending the funds release code to the receiver computer; and
the receiver computer sending the funds release code to the system server computer.

The specified events can comprise one or more of:
the expiry of an agreed settlement date;
the receipt by the receiver computer of acceptance of completion of the transaction;
a prior agreed condition precedent for completion of the transaction being achieved;
a mutually agreed outcome notified by the two entities to the systems server computer; and
a decision by an arbitrator appointed to resolve the dispute.

The establishment of an entity account for a remitter computer is accomplished by the transfer of funds to the escrow account.

In one embodiment of the invention, during the transaction, the receiver computer sends notification of completion of the transaction to the remitter and system server computers and if the remitter computer disputes the satisfactory completion of the transaction prior to an expected settlement date, the steps are performed of:
the remitter computer sends a revised settlement date to the system server computer;
the two entity computers enter into dispute resolution negotiations; and
if, on expiry of the revised settlement date, a satisfactory resolution of the negotiations has not taken place with the release of the funds in the escrow account to one or both of the entity accounts:
the systems server computer establishes an appropriate formal alternative dispute resolution (ADR) procedure.

This allows the parties to the transaction, namely, the remitter computer and the receiver computer to engage in negotiation without involving the system server computer, which negotiations can be conducted with the comfort of both parties, that the funds are held in escrow. This will also avoid a considerable number of difficulties between parties when relatively easily solved events have occurred; such as, for example, a delay in delivery due to difficulties with postal or other delivery services, damage to the goods in transit, or what is often the more likely happening, in that there has been a misunderstanding between the parties. As will be well appreciated, in many situations between buyer and seller, the buyer, when he or she receives the goods, finds that they are not exactly what they require and they wish to return them. The seller may be quite willing to accept the return and, with the present invention, this can be carried out without any great difficulty between the parties. Similarly, sometimes goods are substituted for other ordered and unavailable goods when the seller believes they would be satisfactory and they are not. There are many situations that anybody will appreciate which arise in any trade where the two parties are acting perfectly honourably and honestly, but the transaction is unsatisfactory to one or other of the parties. In situations like that, It is very often the receiver of the goods or services who is unhappy with what has been done. Therefore, in situations such as this, the parties have an opportunity to, resolve the matter between themselves, without involving any third party, although there is still the possibility of third party intervention.

Very often, on the revised settlement date expiring, a new revised settlement date is set to allow negotiations to continue and indeed after a preset number of revised settlement dates have expired, the ADR procedure is initiated unless both entity computers agree to the setting of a further revised settlement date.

It is also preferable that the system server computer records:
the number of transactions for each entity computer whether acting as a receiver computer or a remitter computer, the reception of a revised settlement date for each transaction for that receiver or remitter computer as a default transaction; and
where the number of default transactions exceed a preset limit, the system server computer remotes the entity computer from the system.

Further, the system server computer records:
the number of transactions for each entity computer, acting as a receiver computer or a remitter computer;
the establishment of ADR for each transaction for that receiver or remitter computer as a default transaction; and
where the number of default transactions exceed a present limit, the system server computer removes the entity computer from the system.

In one embodiment of the invention, the preset limit is one or more of:
a number of default transactions in a specified period;
a percentage of the total number of the transactions within a specified period being default transactions.

In this way, the system server computer has control effectively over the entities involved in the system. It should, very quickly, be able to eradicate rogue or unsatisfactory sellers of goods and services because these receiver computers would be involved in a large number of disputes which would allow the system server computer to drop that entity computer from the system. The same would apply with those purchasers of goods and services acting as remitter computers who were seen to behave in an unsatisfactory manner. It would be relatively easy for the recording of such events to enable the systems server computer to decline to handle transactions for that entity computer.

Further, the invention provides a funds transfer method in a system comprising a plurality of entity computers each with means to provide an unique entity identification (ID) and a system server computer interconnected by a communications network, the system server computer having an escrow account associated therewith into and out of which funds may be transferred, the method comprising establishing, prior to or during a funds transfer, an entity account for each entity computer with the system server computer and on a funds transfer being desired between two entity computers, designating, as appropriate, one as a remitter computer and the other as a receiver computer in which the systems server computer and/or the receiver computer are outside the jurisdiction, and then the steps are performed of:
the remitter computer sends transaction details and the receiver entity ID to the system server computer;
from the systems server computer, the remitter computer receives confirmation that the receiver computer has been notified of the availability of funds in the escrow account for the receiver computer entity account which funds are no longer available to the remitter computer;
then, on a specified event occurring, the remitter computer receives confirmation that the receiver computer has had the funds released from the escrow account to the entity account of the receiver computer.

Again this method may be handled in substantially the same way as described above.

In a further method according to the invention, there is provided a funds transfer method in a system comprising a plurality of entity computers each with means to provide an unique entity identification (ID) and a system server computer interconnected by a communications network, the system server computer having an escrow account associated therewith into and out of which funds may be transferred, the method comprising establishing, prior to or during a funds transfer, an entity account for each entity computer with the system server computer and on a funds transfer being desired between two entity computers, designating, as appropriate, one as a remitter computer and the other as a receiver computer when one or both of the entity computers may be outside the jurisdiction and then the steps are performed of:
from the remitter computer, the systems serer computer receives transaction details and the receiver entity ID;
the systems server computer confirms the availability of funds in the escrow account for the receiver computer entity account, which funds are no longer available to the remitter computer;
then, on a specified event occurring, the funds are released by the systems server computer from the escrow account to the entity account of the receiver computer.

As remarked already, substantially the same way of handling these transactions can be carried out, as described above.

It is envisaged that the method according to the present invention may be carried out by providing a computer program comprising program instructions for causing a computer to carry out some or all of the methods described above. Such a computer program may be embodied on a record medium, a computer memory, a read-only memory or carried on an electrical signal carrier.

The invention is also directed towards providing a computer programmed to carry out some or all of the method as described above.

### DETAILED DESCRIPTION OF THE INVENTION

The invention will be more clearly understood from the following description of some embodiments and examples thereof, given by way of example only, with reference to the accompanying drawings, in which:—

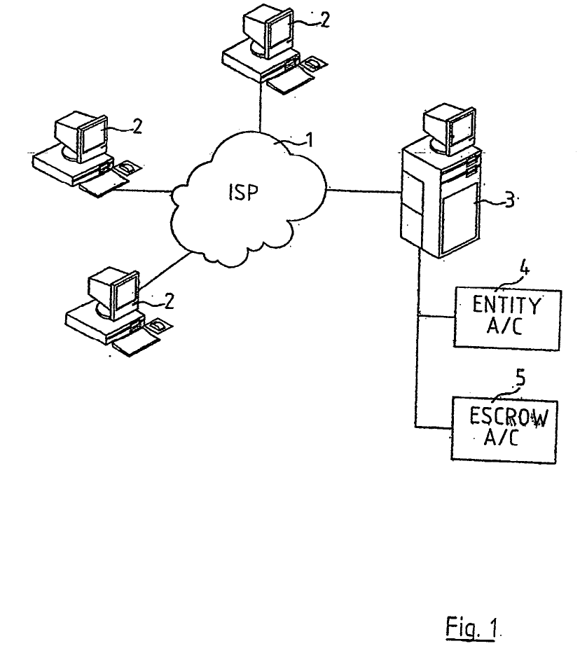

FIG. 1 is layout of a system in which the invention could be carried out; and

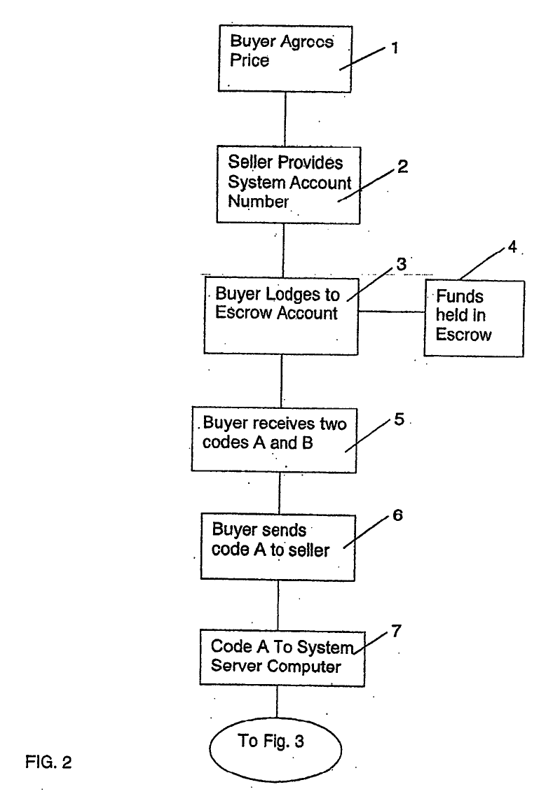

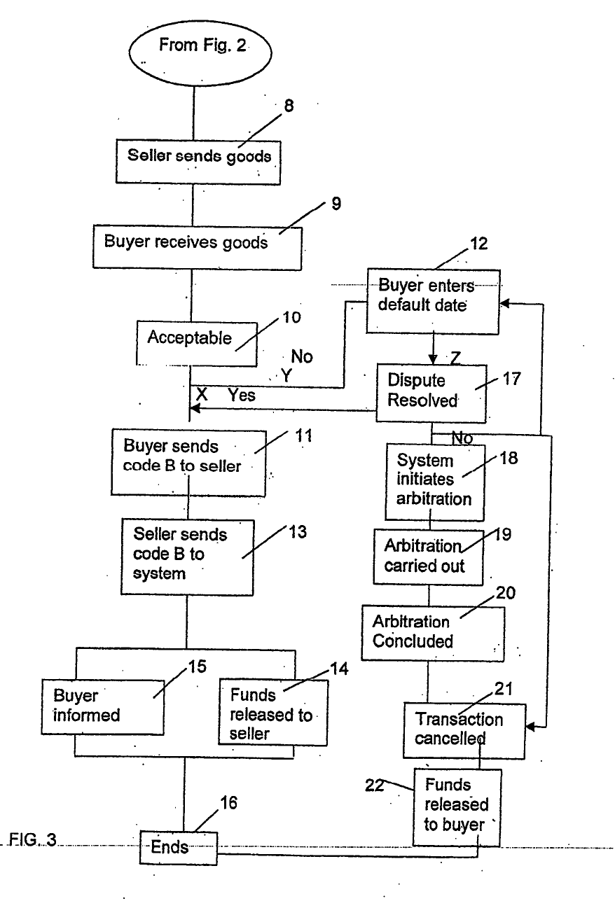

FIGS. 2 and 3 are a flowchart of one method of carrying out the invention.

Referring to the drawings, there is provided a communications network 1 indicating a plurality of computers, namely, entity computers 2 and a system server computer 3. The system server computer 3 has associated therewith a plurality of entity accounts 4 and an escrow account 5.

In operation and dealing firstly with a simple trading situation between a buyer and a seller where the buyer wishes to buy certain goods and the seller agrees to provide them, in this particular system, there is agreed an arbitration system. The two entity computers are correctly described as buyer and seller computers when referring to the purchase of goods and/or services. However, when considering the financial transaction taking place between the two entities, it is more proper to designate them respectively as receiver and remitter computers. The terms are used interchangeably throughout the specification. It should also be appreciated that the terms “buyer/seller” or “remitter/receiver” are references to the role of the computers within the system, as an entity computer in one transaction might be a buyer or remitter and in the next, a seller or receiver.

Referring to FIGS. 2 and 3 there is illustrated a very simple layout of one trading operation. In step 1, the buyer computer agrees a price with the seller computer and in step 2, the seller computer provides a system account number to the buyer computer. Needless to say, this could be any other suitable reference other than an account number such as an email address, trading code, and so on. This is a normal standard reference which would normally be used in a trading situation and must not be confused with the codes used in the invention. The buyer computer, in step 3, lodges money or causes money to be transferred from the buyers entity account, if the buyer has one, or in any case, to an escrow account. In step 4, the funds are received in the escrow account and held in the escrow account. These funds are not available to either the buyer or the seller computers at this stage.

In step 5, the buyer computer receives two codes from the system server computer, namely an initial initiation locking code and a funds release code for simplicity hereinafter called bodes A and B. In step 6, the remitter computer sends code A to the receiver computer. In step 7, the receiver computer provides code A to the system server computer which locks the funds for the benefit of the receiver. In step 8, having received code A which informs the receiver computer that the funds are being held in escrow, the seller sends the goods to the buyer. It will be appreciated that these could be simply services over the internet or the like such as the downloading of music by the seller computer. In step 9, the buyer receives the goods and the buyer then, in step 10, checks the goods. Presuming the goods are acceptable, then in step 11, the remitter computer sends code B to the receiver. Then, in step 13, the receiver computer sends code B to the system server computer and in step 14, the funds are transferred to the receiver entity account and in step 15, the remitter computer is informed that the funds have been released from escrow to the receiver account and in step 16 the transaction is complete.

If, however, the buyer has not accepted the goods, then in step 12, the remitter computer enters a revised settlement date and then enters into negotiations and other discussions with the seller and in step 17, the dispute has either been resolved or not if it has been resolved, step 11 takes place and the remainder of the operation is as described above. If, however, this dispute has not been resolved, then step 12 is repeated by the remitter computer-entering another default date. This may occur a fixed number of times, each time repeating steps 12 and 17 until either the dispute has been resolved or not. If it has not been resolved, then the system server computer initiates arbitration in step 18 and the arbitration is carried out in step 19. Then, arbitration is concluded in step 20 which means that the matter has been resolved between the buyer and seller and the remainder of the trade takes place. Thus steps 11, 13, 14, 15 and 16 are carried out. If, however, the arbitration, when concluded, does not mean that the trade continues, then in step 21, the transaction is cancelled, in step 22 the funds are released to the remitter entity account and then step 16 is carried out to end the transaction. As mentioned above, instead of using arbitration after a certain number of defaults, step 21 may take place without arbitration and the transaction cancelled.

In its simplest, a buy/sell situation uses two codes and essentially a deal is agreed as in any situation, the seller provides the buyer with an account reference number, the buyer makes an escrow payment to the sellers account for the agreed value and the buyers account is in some way debited. If the particular remitter computer has an entity account already established, then that entity account is debited. Alternatively, the remitter computer arranges to transfer the funds to the escrow account. In the normal operation of the account, the system will provide the remitter with two codes (codes A and B) and generally, the remitter will give one of these codes (say, code A) to the seller immediately via email, telephone or so on. Then, the receiver calls up the transaction within his own account established with the system and enters this first code. Generally speaking, the system will inform the remitter, via email, that the receiver computer has entered this first code. The funds are now in escrow and are not available to either party. The remitters account has indeed been debited but the sellers account has not been credited. Once the receiver has delivered the product or service as agreed, then the remitter gives the second code (code B) to the receiver and the receiver calls up the transaction within his system account or entity account and enters the code which then causes the system computer to release the funds and credit the account of the receiver computer. Thus, the transaction ends.

Needless to say, when, for example, the deal is concluded and the payments have been made, the goods are delivered and the buyer does nothing further. The second situation can arise where the buyer changes his or her mind, after making the payment to the escrow account but before the seller has entered code A and delivered it to the system computer. In another situation, the delivery is not made, made partially or the goods or services are unacceptable; in this case, the remitter computer does not send the second code, i.e. the funds release code, to the receiver computer until the problem has been resolved.

It is envisaged that there are many ways in which the process may be carried out. For example, when the remitter computer initially sends the funds to the escrow account, an expected settlement date may be entered whereby the receiver is notified that in the event of failure of the remitter to contact the systems server computer, the funds will be released. Effectively, this is a default date. Then, the system computer will automatically release the funds to the receiver when this default date has passed unless the remitter computer has intervened.

It will be appreciated that the buyer computer can intervene in the process in many ways. Firstly, the remitter computer could intervene before the receiver computer has entered this code A, i.e. the initiation locking code. The remitter can then enter code A and cancel the transaction. The funds are returned to the remitter's account and the receiver is informed of a cancellation. This can only happen when the remitter computer has received both codes and the receiver computer has not yet received code A which will be used as a trigger to supply the goods and services. Therefore, effectively, the whole operation is cancelled prior to initiation.

Before the expected settlement date, the remitter can enter code B that in this case, releases the funds immediately to the receiver's account and then the receiver computer would normally be informed. Alternatively, before the receiver entity has entered code B and before the expected settlement date, the remitter computer can enter code B and defer the expected settlement date, for example, up to seven days. There is thus provided a revised settlement date. This caters for situations where a delivery has not been completed or some discussion is taking place between remitter and receiver and time is needed to resolve it. The receiver computer would then be notified of the extended or revised settlement date which is effectively a default date from the system server computer. Needless to say, this deferring of the settlement date by a revised settlement date can be carried out a number of times and it depends how many times are agreed, for example, in the system. It could, for example, normally be three. At some stage, however, the remitter computer may enter code B with the resultant immediate release of the funds unless some form of dispute resolution has been initiated. This can either be initiated automatically or alternatively, can be initiated by a positive action on behalf of the remitter computer. Needless to say, once this has happened, either the two parties can resolve it themselves or the transaction can be referred to automatic dispute resolution and arbitration.

An essential feature of the invention is that some specified event occurs which allows the funds to be released. The specified event can be an expected settlement date which can be agreed between the parties. It may, for example, be a condition of sale provided by the seller, namely that the settlement date must be adhered to. Obviously, the system allows for this to be extended, but can only be extended by the remitter computer actively doing so. There are other specified events that may be required or could be used. For example, the event could be the receipt by the receiver computer of acceptance of completion of the transaction from the remitter computer. It will be appreciated that there would be no need for the remitter computer to delay acceptance because the money is already in escrow. Alternatively, the specified event could be a prior agreed condition precedent for completion of the transaction. This could, for example, be buyer inspection, It could be some other third party inspection or passing of the goods by an official authority such as, for example, the delivery of a yacht and the need to have its measurement certificate certified. It might also be the requirement that the goods be passed fit for human consumption, and so on. Indeed, it will bo appreciated that the two entitles can have any mutually agreed outcome which may be notified by the two entities to the system server computer as the specified went, namely, the condition precedent for the delivery of the good.

Finally, as will be described below and discussed in more detail, the specified event could be a decision by an arbitrator in the event of mediation between the parties not succeeding.

The following are some examples as to how the process according to the invention may be initialled.

### EXAMPLE 1

### Remitter Knows Receiver and has his Account ID

1. The remitter provides funds, an expected settlement date and/or some other condition for the release of funds and the receiver account identifier to the system server computer
2. The system server computer provides code A and code B to the remitter computer
3. The remitter computer provides code A to the receiver
4. The receiver computer provides code A to the system server computer, which causes the funds to be locked for the benefit of the receiver entity account.

### EXAMPLE 2

### Remitter has No Account ID of Receiver

1. The remitter provides funds and an expected settlement date to the system server computer
2. The system server computer provides the transaction identifier and the initiation locking code A and code B to the remitter computer
3. The remitter computer provides the transaction identifier code A to the receiver computer
4. The receiver computer provides code A the transaction identifier and his account identifier, i.e. his entity account, to the system server computer, which causes the funds to be locked for the benefit of the receiver.

### EXAMPLE 3

### Receiver does not have Remitter Details

1. The receiver computer provides the details of the transaction including his account identifier to the system server computer
2. The system server computer provides a transaction identifier to the receiver computer
3. The receiver computer provides the transaction identifier to the remitter
4. The remitter computer provides the transaction identifier, funds and the expected settlement date to the system server computer
5. The system server computer provides code A and code B to the remitter
6. The remitter computer provides the code A to the receiver.
7. The receiver computer provides the code A to the system server computer, which causes the funds to be locked for the benefit of the receiver.

In the event that the transaction is completed to the satisfaction of both parties there are three possible courses of action.

The remitter computer provides code B to the system server computer with the instruction to release the funds to the seller.

The remitter computer provides code B to the receiver computer.

The receiver computer provides code B to the system server computer with the instruction to release the funds to the receiver.

The remitter computer does nothing and the funds are released to the seller on the expected settlement date.

In the event that the transaction is not completed to the satisfaction of the remitter.

The remitter provides code B to the system server computer with the instruction to put back the expected settlement date. This may be done a number of times in order to provide a period of time to complete the commercial transaction if it is taking longer than expected or to resolve a dispute between the parties.

Should it not be possible to resolve the dispute either within the maximum number of times the date can be put back or by the choice of the remitter, the remitter on providing code B to the system server computer may elect to send the dispute for arbitration.

It will be appreciated that when there are funds only being transferred between the parties without the delivery of goods or services being a condition precedent therefor, it will be relatively simple for one computer to transfer to another entity computer by simply downloading receiver ID and receiving a code from the system server computer. Until the receiver computer is informed by the system server computer that there are funds available, the funds are kept in escrow. Once the receiver computer identifies that the funds are available for him or her, then the receiver computer can inform the remitter computer and the remitter computer can then dispatch code B, either itself to the system server or to the receiver computer for onward transmission. In this way, the remitter can be confident that the funds are being delivered to the right person.

There are certain major advantages with the invention. Firstly, if, for example, a seller is involved in a considerable number of disputes or disagreements with buyers, the systems operators will immediately become aware of this and if can be logged into the systems server computer, such that the systems server computer can refuse to deal with a particular seller or receiver. This will give considerable security to a buyer, since the system will ensure, in most cases, except between private individuals, that the entities are vetted in some way, if not on acceptance by the system, by their performance as they use the system.

There is also a great advantage for the buyer, particularly where the buyer does not know anything about the seller because the escrow account can be used to protect the buyer. At the same time, the escrow account operates automatically such that with the provision of various settlement dates, most of the dispute of disagreements between buyers and sellers can be readily easily handled. In many instances, it will be appreciated that most of the problems that arise will often be problems due to wrong specifications of goods, delays in delivery of goods, In ability to furnish all the goods, and so on. By having the present system, these will be largely overcome. This is not to say that disputes will not arise, however, the system will automatically ensure that a large number of disputes do not occur. There will be sufficient time, one could almost describe it as a “cooling off” time within which the entities will be able to resolve their differences to their mutual satisfaction.

It is envisaged that arbitration, which will be a last resort, will not be used that often.

The innovative feature of the invention can be summarized as follows:
1. The remitter provides funds to the escrow account
2. The system server gives the two codes to the remitter
3. Until the receiver enters the first code, these funds may be retrieved by the remitter
4. The receiver gets code A and he provides this to the system server
5. The funds are now locked to the benefit of the receiver but he cannot access these funds until code B has been provided
6. An event occurs that concludes the transaction (goods are received by the remitter)
7. Provided the remitter is happy, he provides code B to the receiver
8. The receiver then enters code B and he then has access to the funds.

The above is the simple situation with no problems.

However, when a problem arises, one way of solving it, described herein, can be summarized as follows:
1. The remitter is not happy with the goods
2. The remitter may enter code B and signal the existence of a problem to the system server and the server or remitter will select a resolution date by which the problem should be resolved
3. The system server informs the receiver (or not, as the remitter may do this) of this action by the remitter (this provides a breathing space for the two parties to sort out the problem)
4. The remitter will be permitted a fixed number of times that the resolution date may be extended
5. Only after the parties have failed to resolve the problem themselves, dues this system start the arbitration process.

When reference is made to alternative dispute resolution (ADR) in this specification, the reference is made to refer to all forms of dispute resolution and under various arbitration or other mediation rules. It is envisaged that the system severer computer would have available to it a number of such systems and would choose the one most appropriate to the particular circumstances.

One of the great advantages of the present invention is that there is, generally speaking, an onus on the parties to resolve the dispute. There is no advantage to the remitter in not releasing the funds because the funds are not available to the remitter. There is an onus on the receiver to quickly satisfy the remitter so that the remitter will allow the release of the funds.

One of the advantages of the present invention is that by allowing the parties to negotiate and do everything possible between themselves to resolve the dispute, the operators of the system are not involved in the dispute. Since the system will only be available to those entities that agree to join the system, there is a degree of control over the users of the system. This particularly relates to those who would normally be selling goods and services and receiving remittance of funds in this way. If a particular merchant entity using the system is involved in a large number of disputes, then the system server computer has a record of these and, if necessary, can drop that particular entity from the system and disconnect the entity computer from the system. This means, for those entities that are normally buyers within the system, that they have some degree of confidence in the merchants or traders using the system. There is, while not necessarily a guarantee from the system of the probity of an entity trading therein, there is a presumption of it, and this presumption can be reasonably made by a buyer, that such an entity will operate in a reasonable way. There will also be a presumption for those entities who normally act as receiver computers, that the people they are dealing with will honour their financial obligations. As far as the merchants or sellers are concerned, having the funds automatically in escrow is of considerable comfort. This is particularly important for those entities selling relatively low cost items. Whether these items be downloaded directly between entity computers or whether they result in the receiver entity computer, when acting as a seller, having to send goods to the other entity. If the actual monetary value of the transaction is low, it then becomes uneconomic for the provider of those goods and services to engage in any form of litigation.

It will be appreciated that the nature of the present invention is such that as a matter of course, many of the tasks required to carry out the invention will be performed outside the jurisdiction, and possibly in many jurisdictions. Thus, where it is stated that a particular action is, or actions are, performed, it may be that only the end result of the action may be delivered into the jurisdiction. Thus, for example, the system server computer may be considerably geographically remote from one or both of the entity computers. Accordingly, all that may be carried out within the user computer is very few steps of the invention. However, such steps cannot be performed without the availability of the data transmitted to or from it with the other computers.

Therefore, it is submitted that the appended claims be interpreted not literally but having regard to this circumstance and that the carrying out of some of the steps of the invention within the jurisdiction covered by any patent for onward transmission of the results of the carrying out of those steps shall be deemed to be infringement within the jurisdiction in the sense that delivery into or receipt within the jurisdiction of the results of some steps of the method carried out outside the jurisdiction be deemed to be the same as of the steps had been carried out within the jurisdiction.

Accordingly, a statement that a particularly computer carries out a particular task is deemed to cover not alone the carrying out of the task or operation within the jurisdiction but also the carrying out of the task outside the jurisdiction and the delivery of the result of the completion of the task to within the jurisdiction and the action required within the jurisdiction is the reception of the result of the action carried out outside the jurisdiction.

In the specification the terms “comprises, comprised and comprising” or any variation thereof and the terms “include, includes, included and including” or any variation thereof are considered to be totally interchangeable and they should all be afforded the widest possible interpretation and vice versa.

The invention is not limited to the embodiment hereinbefore described but may be varied in both construction and detail.

1-51. (canceled)

52. A funds transfer method in a system comprising a plurality of entity computers each with means to provide an unique entity identification (ID) and a system server computer interconnected by a communications network, the system server computer having an escrow account associated therewith into and out of which funds may be transferred, the method comprising establishing, prior to or during a funds transfer, an entity account for each entity computer with the system server computer and on a funds transfer being desired between two entity computers, designating, as appropriate, one as a remitter computer and the other as a receiver computer and then the steps are performed of:
the remitter computer sends transaction details and the receiver entity ID to the system server computer;
the systems server computer generates two different codes, namely, a locking code and a funds release code, in which the locking code is used to control the holding of the funds in the escrow account and the funds release code is used to control the release of the funds from the escrow account;
the systems server computer confirms, by sending the locking code and funds release code to the remitter computer, the availability of funds in the escrow account for the receiver computer entity account; and the remitter computer sends the locking code to the receiver computer and the receiver computer sends the locking code to the systems server computer which locks the funds for that receiver computer so that the funds are no longer available to the remitter computer; and
in which on a specified event occurring, the funds release code is sent to the system server computer and the system server computer releases the funds from the escrow account to the receiver computer entity account.

53. A method as claimed in claim 52, in which on the system server computer confirming the availability of the funds in the escrow account, the system server computer sends the two codes to the remitter computer and if the remitter computer does not send the locking code to the other entity but sends it to the systems server computer, the transaction is cancelled and the funds in the escrow account are released to the remitter entity account.

54. A method as claimed in claim 52, in which the sending of the funds release code to the system server computer comprises:
the remitter computer sending the funds release code to
the receiver computer; and
the receiver computer sending the funds release code to the system server computer.

55. A method as claimed in claim 52, in which the specified event comprises one or more of:
the expiry of an agreed settlement date;
the receipt by the receiver computer of acceptance of completion of the transaction;
a prior agreed condition precedent for completion of the transaction being achieved;
a mutually agreed outcome notified by the two entities to the systems server computer; and
a decision by an arbitrator appointed to resolve the dispute.

56. A method as claimed in claim 52, in which the establishment of an entity account for a remitter computer is accomplished as part of the transfer of funds to the escrow account.

57. A method as claimed in claim 52, in which during the transaction, the remitter computer disputes the satisfactory completion of the transaction prior to an expected settlement date, the steps are performed of:
the remitter computer sends a revised settlement date to the system server computer;
the two entity computers enter into dispute resolution negotiations; and
if, on expiry of the revised settlement date, a satisfactory resolution of the negotiations has not taken place with the release of the funds in the escrow account to one or both of the entity accounts:
the systems server computer establishes an appropriate formal alternative dispute resolution (ADR) procedure.

58. A method as claimed in claim 57, in which on the revised settlement date expiring, a new revised settlement date is set to allow negotiations to continue.

59. A method as claimed in claim 57, in which after a preset number of revised settlement dates have expired, the ADR procedure is initiated unless both entity computers agree to the setting of a further revised settlement date.

60. A method as claimed in claim 57, in which the system server computer records:
the number of transactions for each entity computer, acting as a receiver computer;
the reception of a revised settlement date for each transaction for that receiver computer as a default transaction; and
where the number of default transactions exceed a preset limit, the system server computer removes the entity computer from the system.

61. A method as claimed in claim 57, in which the system server computer records:
the number of transactions for each entity computer, acting as a remitter computer;
the reception of a revised settlement date for each transaction for that remitter computer as a default transaction; and
where the number of default transactions exceed a preset limit, the system server computer removes the entity computer from the system.

62. A method as claimed in claim 57, in which the sending of the funds release code by the remitter computer to the systems server computer permits the remitter computer to revise the settlement date.

63. A method as claimed in claim 60, in which the preset limit is one or more of:
a number of default transactions in a specified period;
a percentage of the total number of the transactions within a specified period being default transactions.

64. A method as claimed in claim 52 wherein each independent step is adapted to be sequentially carried out between two or more jurisdictions.

65. A funds transfer method in a system comprising a plurality of entity computers each with means to provide an unique entity identification (ID) and a system server computer interconnected by a communications network, the system server computer having an escrow account associated therewith into and out of which funds may be transferred, the method comprising establishing, prior to or during a funds transfer, an entity account for each entity computer with the system server computer and on a funds transfer being desired between two entity computers, designating, as appropriate, one as a remitter computer and the other as a receiver computer in which the systems server computer and/or the receiver computer are outside the jurisdiction, and then the steps are performed of:
the remitter computer sends transaction details and the receiver entity ID to the system server computer;
generating two different codes, namely, a locking code and a funds release code, in which the locking code is used to control the holding of the funds in the escrow account and the funds release code is used to control the release of the funds from the escrow account;
from the systems server computer, the remitter computer receives confirmation that the receiver computer has been notified of the availability of funds in the escrow account for the receiver computer entity account, which funds are no longer available to the remitter computer;
in which on the system server computer confirming the availability of the funds in the escrow account, the remitter computer receives a funds release code from the system server computer and confirmation that a locking code was sent to the receiver computer; and
then on a specified event occurring, the funds release code is sent to the system server computer instructing the system server computer to release the funds from the escrow account to the receiver computer entity account.

66. A funds transfer method in a system comprising a plurality of entity computers each with means to provide an unique entity identification (ID) and a system server computer interconnected by a communications network, the system server computer having an escrow account associated therewith into and out of which funds may be transferred, the method comprising establishing, prior to or during a funds transfer, an entity account for each entity computer with the system server computer and on a funds transfer being desired between two entity computers, designating, as appropriate, one as a remitter computer and the other as a receiver computer when one or both of the entity computers may be outside the jurisdiction and then the steps are performed of:
from the remitter computer, the systems server computer receives transaction details and the receiver entity ID;
generating two different codes, namely, a locking code and a funds release code, in which the locking code is used to control the holding of the funds in the escrow account and the funds release code is used to control the release of the funds from the escrow account;
the systems server computer confirms the availability of funds in the escrow account for the receiver computer entity account, which funds are no longer available to the remitter computer;
in which on the system server computer confirming the availability of the funds in the escrow account, the system server computer sends the locking code to the receiver computer and the funds release code to the remitter computer, and
on a specified event occurring, the funds release code is received by the system server computer and the system server computer releases the funds from the escrow account to the receiver computer entity account.

67. A funds transfer method in a system comprising a plurality of entity computers each with means to provide an unique entity identification (ID) and a system server computer interconnected by a communications network, the system server computer having an escrow account associated therewith into and out of which funds may be transferred, the method comprising establishing, prior to or during a funds transfer, an entity account for each entity computer with the system server computer and on a funds transfer being desired between two entity computers, designating, as appropriate, one as a remitter computer and the other as a receiver computer in which the systems server computer and/or the receiver computer are outside the jurisdiction, and then the steps are performed of:
the remitter computer sends transaction details and the receiver entity ID to the system server computer;
generating two different codes, namely, a locking code and a funds release code, in which the locking code is used to control the holding of the funds in the escrow account and the funds release code is used to control the release of the funds from the escrow account;
from the systems server computer, the remitter computer receives confirmation that the receiver computer has been notified of the availability of funds in the escrow account for the receiver computer entity account, which funds are no longer available to the remitter computer;
in which on the system server computer confirming the availability of the funds in the escrow account, the remitter computer receives a funds release code from the system server computer and confirmation that the locking code was sent to the receiver computer and on a specified event occurring, the funds release code is sent to the system server computer instructing the system server computer to release the funds from the escrow account to the receiver computer entity account;
in which during the transaction, the remitter computer disputes the satisfactory completion of the transaction prior to an expected settlement date, the steps are performed of:
the remitter computer sends a revised settlement date to the system server computer;
the two entity computers enter into dispute resolution negotiations; and
if, on expiry of the revised settlement date, a satisfactory resolution of the negotiations has not taken place with the release of the funds in the escrow account to one or both of the entity accounts:
the systems server computer establishes an appropriate formal alternative dispute resolution (ADR) procedure.

68. A computer program comprising program instructions for causing a computer to carry out some or all of the method of claim 52.

69. A computer program according to claim 68, embodied on a record medium.

70. A computer program according to claim 68, stored in a computer memory.

71. A computer program according to claim 68, embodied in a read-only memory.

72. A computer program according to claim 68, carried on an electrical signal carrier.

73. A computer programmed to carry out some or all of the method of claim 52.
